(19) United States
(12) Patent Application Publication
(10) Pub. No.: US 2014/0046594 A1
(43) Pub. Date: Feb. 13, 2014

(54) MOBILE-BODY NAVIGATION DEVICE AND MOBILE-BODY NAVIGATION SYSTEM

(71) Applicants: Masashi Watanabe, Tokyo (JP); Takashi Tamada, Tokyo (JP); Yasushi Kodaka, Tokyo (JP); Hidekazu Arita, Tokyo (JP)

(72) Inventors: Masashi Watanabe, Tokyo (JP); Takashi Tamada, Tokyo (JP); Yasushi Kodaka, Tokyo (JP); Hidekazu Arita, Tokyo (JP)

(73) Assignee: MITSUBISHI ELECTRIC CORPORATION, Tokyo (JP)

(21) Appl. No.: 14/111,975

(22) PCT Filed: Jun. 23, 2011
(86) PCT No.: PCT/JP2011/003593

§ 371 Date: Oct. 15, 2013

(51) Int. Cl. G01C 21/34

(52) U.S. Cl. CPC G01C 21/34
USPC 701/533

(57) ABSTRACT

A mobile-body navigation device includes a route search unit 12 for searching for a route to a destination; a communication device 7 and communication interface unit 9 constituting a receiving unit for receiving information about a deviation-prone connection route on a route identified in accordance with probe information; a deviation-prone connection route caution instructing unit 14 for giving instructions to send notification of the presence or absence of the deviation-prone connection route on the route the route search unit 12 searches for in accordance with the information about the deviation-prone connection route the receiving unit receives; and a display device 8 for displaying a guide map including the presence or absence of the deviation-prone connection route on the route in response to the instructions.

### TECHNICAL FIELD

The present invention relates to a mobile-body navigation device for providing a user with a deviation-prone route from a guide route, and to a mobile-body navigation system using the device.

### BACKGROUND ART

For example, a server disclosed in Patent Document 1 collects from a plurality of vehicles data about a deviation or return from a first guide route, analyzes driving path data from the deviation point to the return point from the data collected, and obtains the optimum route that matches better to the real road conditions than the guide route that is calculated first by a navigation device as expert route data to share the data among a plurality of users.

### PRIOR ART DOCUMENT

Patent Document 1: Japanese Patent Laid-Open No 2010-237178.

### DISCLOSURE OF THE INVENTION

### Problems to be Solved by the Invention

Conventional techniques typified by the Patent Document 1 assume that a user deviates from the guide route intentionally, and do not consider a case of an unexpected route departure due to a mistake of the user. Accordingly, they cannot provide the user with a deviation-prone route, thereby offering a problem of being unable to decide an appropriate route considering the deviation-prone route.

The present invention is implemented to solve the foregoing problem. Therefore it is an object of the present invention to provide a mobile-body navigation device capable of determining an appropriate route by considering the deviation-prone connection route that can misleads the user often, and a mobile-body navigation system using it.

### Means to Solve the Problem

A mobile-body navigation device in accordance with the present invention comprises: a route search unit for searching for a route to a destination; a receiving unit for receiving information about a deviation-prone connection route on the route identified in accordance with probe information; an instructing unit for giving instructions to send notification of presence or absence of a deviation-prone connection route on the route the route search unit searches for in accordance with the information about the deviation-prone connection route the receiving unit receives; and a display unit for displaying a guide map including the presence or absence of the deviation-prone connection route on the route in response to the instructions.

Here, the term “deviation-prone connection route” refers to a route that can mislead a driver frequently, and the term “deviation-prone point” refers to a point (such as an intersection) on the deviation-prone connection route, which can mislead the driver. When passing through a deviation-prone point on a deviation-prone connection route from a route other than the deviation-prone connection route, the deviation-prone point is not reckoned as a deviation-prone point.

### Advantages of the Invention

According to the present invention, it offers an advantage of being able to decide an appropriate route by considering the deviation-prone connection route that can mislead the user frequently.

### BRIEF DESCRIPTION OF THE DRAWINGS

FIG. 1 is a block diagram showing a configuration of a mobile-body navigation system of an embodiment 1 in accordance with the present invention;

FIG. 2 is a flowchart showing the route search processing of the mobile-body navigation system of the embodiment 1;

FIG. 3 is a diagram showing a display example of a setting section for a deviation-prone connection route on a map and for setting the necessity for re-searching for a route;

FIG. 4 is a diagram showing a display example of the route after the re-searching of FIG. 3; and

FIG. 5 is a flowchart showing the processing of a probe server of the embodiment 1.

### BEST MODE FOR CARRYING OUT THE INVENTION

The best mode for carrying out the invention will now be described with reference to the accompanying drawings to explain the present invention in more detail.

### Embodiment 1

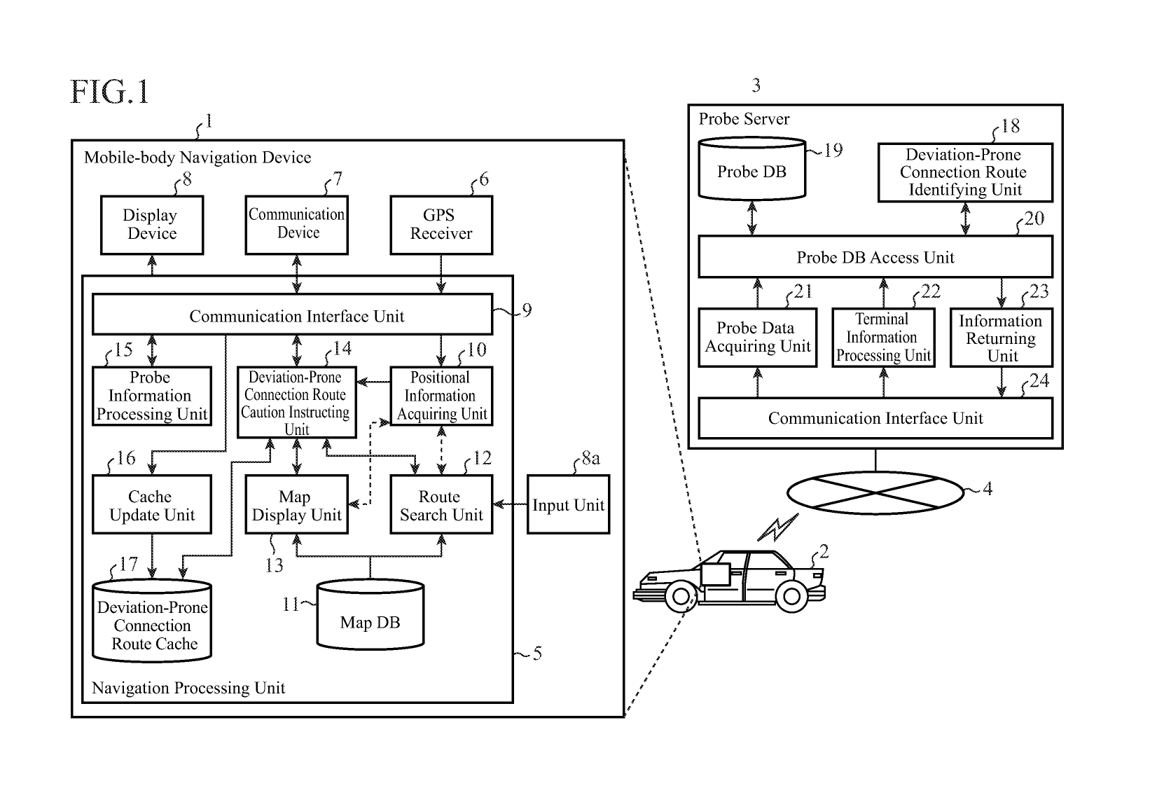

FIG. 1 is a block diagram showing a configuration of a mobile-body navigation system of an embodiment 1 in accordance with the present invention. In FIG. 1, the mobile-body navigation system of the embodiment 1 comprises a mobile-body navigation device 1 mounted in a mobile body (vehicle 2, for example) and a probe server 3. The mobile-body navigation device 1, which is installed in the vehicle 2, is a navigation device that is capable of communicating with the probe server 3 via a communication network 4, and that comprises a navigation processing unit 5, a GPS (Global Positioning System) receiver 6, a communication device 7, a display device 8, and an input unit 8a.

In the foregoing configuration, the GPS receiver 6 is a receiver for receiving GPS radio waves for locating a vehicle from GPS satellites, and the communication device 7, which is a communication device for communicating with the probe server 3 via the communication network 4, operates as a receiving unit for receiving from the probe server 3 information about a deviation-prone connection route on a route. It corresponds to a communication processing module incorporated into the mobile-body navigation device 1 or to a mobile phone connected to the mobile-body navigation device 1, for example.

In addition, the display device 8, which is a display device for displaying on its screen the information acquired by the processing of the navigation processing unit 5, carries out display of various menu images, map display by a map display unit 13, and display of a guide map including a deviation-prone connection route instructed by a deviation-prone connection route caution instructing unit 14. The input unit 8a, which is a component for receiving a setting input of a destination or various operation of a user, is realized by a touch screen mounted on the screen of the display device 8, for example.

The navigation processing unit 5, which is a component for carrying out navigation processing such as a route search, route guidance and map display, comprises a communication interface unit 9, a positional information acquiring unit 10, a map database (DB) 11, a route search unit 12, a map display unit 13, a deviation-prone connection route caution instructing unit 14, a probe information processing unit 15, a cache update unit 16 and a deviation-prone connection route cache 17.

The communication interface unit 9 is an interface for carrying out communication control of the communication device 7, and for relaying communication between the probe server 3 and the navigation processing unit 5 via the communication network 4. The positional information acquiring unit 10 is a component for obtaining the positional information (latitude and longitude) of the vehicle from the analysis result of the GPS radio waves received by the GPS receiver 6. The positional information of the vehicle is delivered from the positional information acquiring unit 10 to the navigation processing unit 5. The positional information can be obtained by using sensor information acquired from a vehicle speed sensor, acceleration sensor and angular velocity sensor in addition to the analysis result of the GPS radio waves.

The map DB 11 is a database that records map data used by the navigation processing. The map data contains topographic map data, house map data, road network and the like. The route search unit 12 is a component for searching for a guide route using a destination set through the input unit 8a, the positional information of the vehicle acquired by the positional information acquiring unit 10 and the map data stored in the map DB 11, and for making route guidance based on the guide route. The map display unit 13 is a component for displaying a map on the screen of the display device 8 using the map data of the map DB 11.

The deviation-prone connection route caution instructing unit 14 is an instructing unit for acquiring information about a deviation-prone connection route from the probe server 3 via the communication network 4, and for instructing the map display unit 13 to display a guide map about the deviation-prone connection route. The probe information processing unit 15 is a component for executing processing using the probe information the sensors mounted in the vehicle detects. For example, the probe information processing unit 15 uploads the probe information about the vehicle to the probe server 3 via the communication device 7.

The cache update unit 16 is an update unit for acquiring information about the deviation-prone connection route from the probe server 3 via the communication network 4, and for updating the contents of the deviation-prone connection route cache 17. The deviation-prone connection route cache 17 is a storage unit for storing the information about the deviation-prone connection route.

The probe server 3, which is a server for collecting and managing the probe information, comprises a deviation-prone connection route identifying unit 18, a probe database (DB) 19, a probe DB access unit 20, a probe data acquiring unit 21, a terminal information processing unit 22, an information returning unit 23 and a communication interface unit 24.

The deviation-prone connection route identifying unit 18 is a component for identifying from the probe information registered in the probe DB 19 the deviation-prone connection route due to a mistake of a driver of the vehicle that includes the mobile-body navigation device 1. The probe DB 19 is a database for recording the probe information detected in an unspecified large number of vehicles. Incidentally, the probe information, which is information indicating the driving path of the vehicle detected in the vehicle during driving, contains the positional information (latitude and longitude) of the vehicle, the time, stoppage time, time and distance to the destination and the like.

In addition, as for each connection route, the probe DB 19 stores a count value of a link indicating a road to which a vehicle actually exits, information (a warning flag) indicating whether the connection route is the deviation-prone connection route the deviation-prone connection route identifying unit 18 identifies or not, and a link ID (referred to as “warning link ID” from now on) that brings about frequent departures. As for the foregoing count value, it is separately counted for all the links (including a guide link) extending from the connection point of the connection route. However, if the exit link from the intersection differs from the guide link and when a decision is made that the deviation from the guide link is intentional, the count value for the exit link is not counted up. As for the warning flag and the warning link ID, they are determined in accordance with the count value (they are determined in such a manner that the warning flag becomes true when the ratio of exits for links other than the guide link is not less than a prescribed value, and that the ID of the link with the greatest exit count value among the connection links other than the guide link is decided as the warning link ID). As for these information items, they can be divided in accordance with a time zone or the weather. This makes it possible to provide appropriate information about a route where a deviation occurs frequently only during the night or only in case of rain.

The probe DB access unit 20, which is a component for gaining access to the probe DB 19 to exchange probe information, writes the probe information the probe data acquiring unit 21 acquires, and reads from the probe DB 19 the probe information requested by the deviation-prone connection route identifying unit 18, for example. In addition, the probe DB access unit 20 converts the probe information the probe data acquiring unit 21 acquires to the time required per road link, and writes it in the probe DB 19.

The probe data acquiring unit 21 is a component for acquiring via the communication interface unit 24 the probe information about an unspecified large number of vehicles (probe cars) transmitted via the communication network 4 and for outputting it to the probe DB access unit 20.

The terminal information processing unit 22 is a component for extracting from the information received via the communication interface unit 24 the probe information or route information from the mobile-body navigation device 1 and for outputting it to the probe DB access unit 20.

The information returning unit 23 is a returning unit for sending the deviation-prone connection route identified on the route of the requesting vehicle back to the mobile-body navigation device 1 of the requesting vehicle via the communication interface unit 24. The communication interface unit 24 is an interface for relaying communication between the probe server 3 and an external device (mobile-body navigation device 1, for example) via the communication network 4.

Next, the operation will be described.

### (1) Route Decision Considering Deviation-Prone Connection Route.

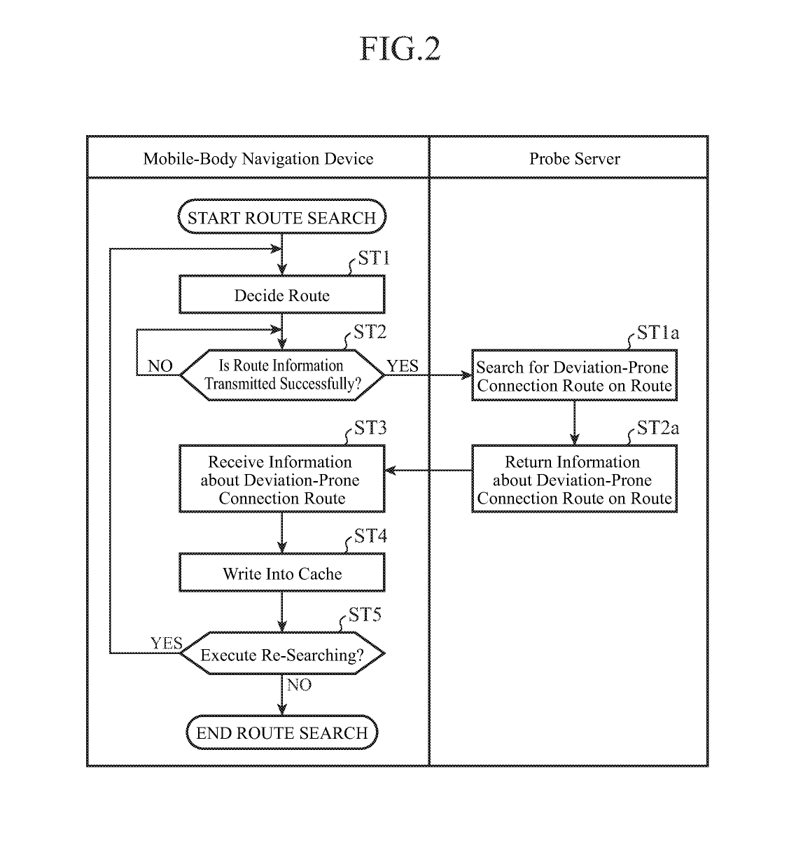

FIG. 2 is a flowchart showing the route search processing of the mobile-body navigation system of the embodiment 1.

First, in the mobile-body navigation device 1, the positional information acquiring unit 10 acquires the positional information (latitude and longitude) of the vehicle (vehicle 2) from the analysis result of the GPS radio waves the GPS receiver 6 receives. Then the positional information is delivered to the route search unit 12. In addition, it is assumed that a user has set a destination to the route search unit 12 using the input unit 8a.

The route search unit 12 executes the route search using the destination set via the input unit 8a and the positional information of the vehicle 2 the positional information acquiring unit 10 acquires and the map data of the map DB 11, and decides the route (step ST1). Here, it identifies the starting point using the positional information the positional information acquiring unit 10 acquires and calculates the route connecting the starting point to the destination.

Next, the communication device 7 transmits the route information (link IDs indicating the links of the guide route) of the route the route search unit 12 searches for to the probe server 3 via the communication interface unit 9 (step ST2). If a communication failure occurs in this case, the communication is retried. For example, the communication device 7 tries receiving by a predetermined number of times, thereby being able to receive the information positively.

The probe server 3 receives the route information transmitted from the mobile-body navigation device 1 via the communication interface unit 24, terminal information processing unit 22, and probe DB access unit 20, and delivers it to the deviation-prone connection route identifying unit 18.

The deviation-prone connection route identifying unit 18 recognizes the link IDs of the route from the route information sent from the mobile-body navigation device 1, and the probe DB access unit 20 searches for the deviation-prone connection route on the route from a warning flag value corresponding to the link IDs identified among the probe information registered in the probe DB 19 (step ST1a).

Next, when the probe DB access unit 20 searches for the deviation-prone connection route on the route, the deviation-prone connection route identifying unit 18 extracts the link IDs of the road corresponding to the deviation-prone connection route from the probe DB 19, and supplies them to the information returning unit 23 as the information about the deviation-prone connection route. The information returning unit 23 sends the information about the deviation-prone connection route back to the requesting mobile-body navigation device 1 via the communication interface unit 24 (step ST2a).

In the mobile-body navigation device 1, the communication device 7 receives the information about the deviation-prone connection route identified by the probe server 3 via the communication interface unit 9 (step ST3). the cache update unit 16 writes the information about the deviation-prone connection route the communication device 7 receives into the deviation-prone connection route cache 17 (step ST4). Incidentally, the communication device 7 receives the information about the deviation-prone connection route via the communication interface unit 9 at intervals of a prescribed distance covered or at intervals of a prescribed elapsed time.

Next, the deviation-prone connection route caution instructing unit 14 reads out the information about the deviation-prone connection route from the deviation-prone connection route cache 17, and supplies it to the map display unit 13. The map display unit 13 displays a map and the deviation-prone connection route on the screen of the display device 8 by using the information about the deviation-prone connection route and the road links of the map DB 11.

Next, in accordance with the information about the deviation-prone connection route, the deviation-prone connection route caution instructing unit 14 displays on the screen of the display device 8 a setting section for making an inquiry about the necessity for re-searching in addition to the map display on the map display unit 13, and accepts the necessity for re-searching (step ST5).

Incidentally, if the information about the deviation-prone connection route indicates that the route which has the route information transmitted at step ST2 does not contain the deviation-prone connection route, the deviation-prone connection route caution instructing unit 14 does not display the setting section for making an inquiry about the necessity for re-searching or does not accept the necessity for re-searching.

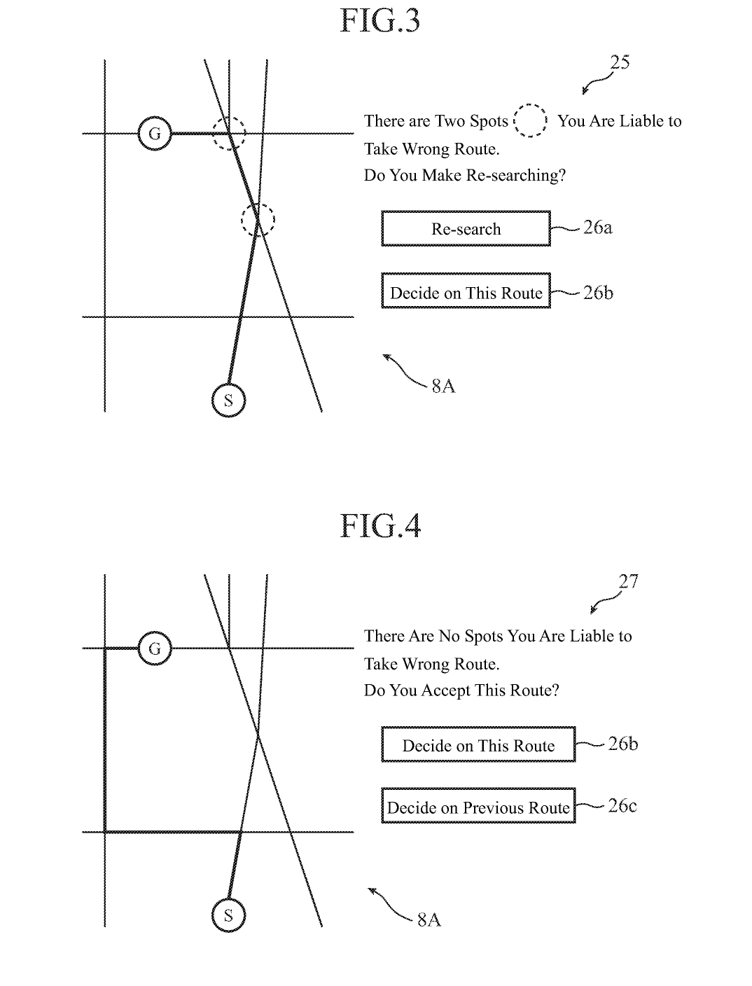

FIG. 3 is a diagram showing a display example of the setting section for setting the deviation-prone connection route on the map and the necessity for re-searching for the route, which shows a case where the route decided at step ST1 includes a deviation-prone connection route. On the screen 8A shown in FIG. 3, the route from the starting point S to the destination G includes a deviation-prone connection route passing through deviation-prone points (encircled by dashed circles).

As shown in FIG. 3, the deviation-prone connection route caution instructing unit 14 outputs voice guidance 25 such as “there are two spots you are liable to take the wrong route. Do you make re-searching?” and displays on the screen 8A of the display device 8 a soft key 26a indicating “re-search” and a soft key 26b indicating “decide on the route” in addition to the map display including the deviation-prone connection route. The user makes a decision on the necessity for re-searching by referring to the screen 8A, and sets the necessity for re-searching or not by operating one of the soft keys 26a and 26b using the input unit 8a.

When the user decides the re-searching by pushing the soft key 26a using the input unit 8a (YES at step ST5), the deviation-prone connection route caution instructing unit 14 instructs the route search unit 12 to search for a new route from the starting point S to the destination G, which will exclude the deviation-prone connection route as much as possible. This will return the processing to step ST1 so that the route search unit 12 executes the re-searching immediately.

Next, the deviation-prone connection route caution instructing unit 14 directs the communication device 7 to transmit the route information about the route re-searched by the route search unit 12 to the probe server 3 via the communication interface unit 9. After that, the foregoing processing is repeated to receive the information about the deviation-prone connection route on the re-searched route from the probe server 3.

FIG. 4 is a diagram showing a display example of the route after the re-searching of FIG. 3, which shows a case where the information about the deviation-prone connection route on the re-searched route does not have a deviation-prone connection route on the route. In this case, as shown in FIG. 4, for example, the deviation-prone connection route caution instructing unit 14 outputs voice guidance 27 such as “there is no spots you are liable to take a wrong route. Do you take the route?”, and displays on the screen 8A of the display device 8 the soft key 26b indicating “decide on the route” and a soft key 26c indicating “decide on the previous route” in addition to the map display including the route. This enables the user to select one of the routes before and after the re-searching.

Unless a decision is made that the re-searching is executed as described above (NO step ST5), the route search is terminated, followed by the guide processing using the route at this point as the guide route.

### (2) Notification of Deviation-Prone Connection Route Involved in Update of Probe DB 19.

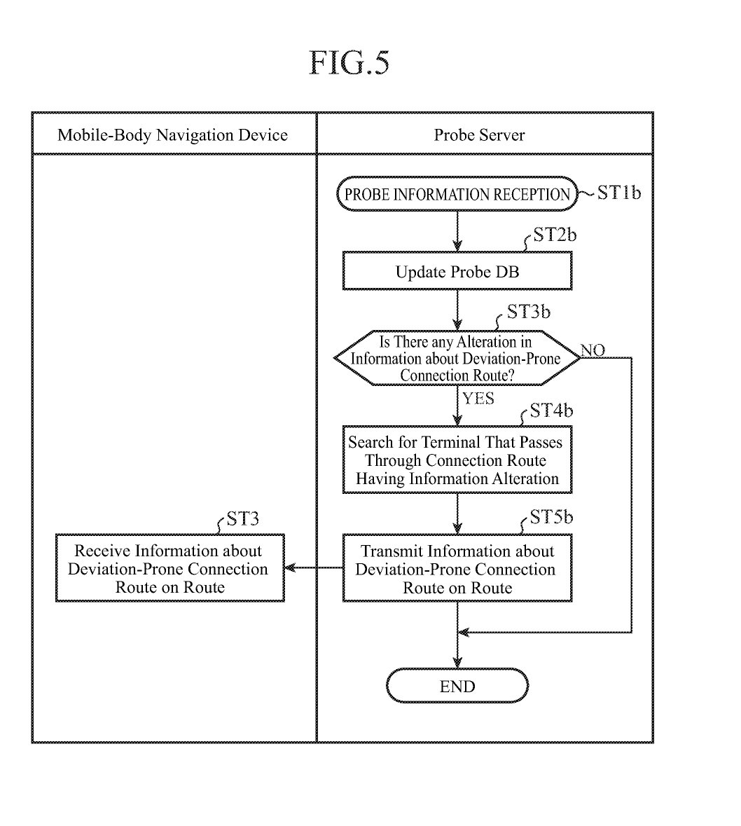

FIG. 5 is a flowchart showing the processing of the probe server of the embodiment 1, which shows the processing of the probe server 3 that sends the information about the deviation-prone connection route accompanying the update of the probe information.

First, the probe data acquiring unit 21 acquires the probe information about an unspecified large number of vehicles (probe cars) via the communication interface unit 24 (step ST1b).

The probe DB access unit 20 updates the contents of the probe DB 19 using the probe information the probe data acquiring unit 21 acquires (step ST2b).

Next, the probe DB access unit 20 decides on whether the information about the deviation-prone connection route is altered by the update of the probe DB 19 or not (step ST3b). Unless the information about the deviation-prone connection route is altered (NO at step ST3b), the processing is closed.

On the other hand, as for the mobile-body navigation device 1 to which the information about the deviation-prone connection route is sent before, the probe DB access unit 20 stores the guide route thereof.

If the information about the deviation-prone connection route is altered (YES at step ST3b), the probe DB access unit 20 searches the stored mobile-body navigation devices 1 for the mobile-body navigation device 1 using the route including the altered deviation-prone connection route as the guide route (step ST4b).

Next, designating the searched mobile-body navigation device 1 as the transmission destination, the probe DB access unit 20 supplies the information returning unit 23 with the information about the deviation-prone connection route.

The information returning unit 23 sends the information about the deviation-prone connection route back to the mobile-body navigation device 1 via the communication interface unit 24 (step ST5b).

In the mobile-body navigation device 1, the communication device 7 receives the information about the deviation-prone connection route after the update via the communication interface unit 9 (step ST3).

The cache update unit 16 writes the information about the deviation-prone connection route after the update the communication device 7 receives into the deviation-prone connection route cache 17. Incidentally, the communication device 7 receives the information about the deviation-prone connection route via the communication interface unit 9 at intervals of a prescribed distance covered or at intervals of a prescribed elapsed time.

After that, the deviation-prone connection route caution instructing unit 14 reads the information about the deviation-prone connection route after the update from the deviation-prone connection route cache 17, and executes the processing described before.

Thus, the route including a deviation-prone connection route is provided in accordance with the information dynamically updated using the new probe information, and a decision is made as to the necessity for re-searching.

As described above, according to the present embodiment 1, it comprises the route search unit 12 for searching for a route to the destination; the communication device 7 and communication interface unit 9 constituting a receiving unit for receiving the information about the deviation-prone connection route on the route identified in accordance with the probe information; the deviation-prone connection route caution instructing unit 14 for instructing to send notification of the presence or absence of the deviation-prone connection route on the route the route search unit 12 searches for in accordance with the information about the deviation-prone connection route the receiving unit receives; and the display device 8 for displaying the guide map containing the presence or absence of the deviation-prone connection route on the route in response to the instructions.

The embodiment with the configuration can decide on an appropriate route by considering a deviation-prone connection route which can often mislead a user into a wrong route.

In addition, according to the present embodiment 1, it comprises the deviation-prone connection route cache 17 for storing the information about the deviation-prone connection route the receiving unit receives, wherein according to the information about the deviation-prone connection route readout of the deviation-prone connection route cache 17, the deviation-prone connection route caution instructing unit 14 instructs to send the notification of the presence or absence of the deviation-prone connection route on the route the route search unit 12 searches for. Thus, since the present embodiment stores the information about the deviation-prone connection route in the cache 17, it can positively obtain the information about the deviation-prone connection route in spite of a communication failure or the like with the probe server 3, thereby being able to decide the route considering it.

Furthermore, according to the present embodiment 1, since the receiving unit retries to receive the information about the deviation-prone connection route when it fails to receive the information about the deviation-prone connection route, it can receive the information about the deviation-prone connection route more positively.

In addition, according to the present embodiment 1, it comprises the input unit 8a for accepting the input, wherein when the input unit 8a accepts the re-searching of the route, the deviation-prone connection route caution instructing unit 14 instructs the route search unit 12 to execute the re-searching of the route, and the route search unit 12 carries out the re-searching of the route in response to the instructions. With such a configuration, the present embodiment can decide the guide route that is much less liable to mislead by executing the re-searching when a lot of deviation-prone connection routes are present on the route decided previously, and by obtaining the route with a smaller number of deviation-prone connection routes.

Furthermore, according to the present embodiment 1, since the receiving unit receives the information about the deviation-prone connection route at intervals of the prescribed distance covered by the vehicle or at intervals of the prescribed elapsed time, it can acquire the latest information about the deviation-prone connection route, which dynamically varies in accordance with the time zone (day and night, time specified bus lane) and to weather (fog, snow or the like), thereby being able to improve the reliability of the information.

Moreover, according to the present embodiment 1, the mobile-body navigation system comprises the mobile-body navigation device 1 and the probe server 3 that includes the deviation-prone connection route identifying unit 18 for identifying the deviation-prone connection route on the route by collecting the probe information and the information returning unit 23 for sending the information about the deviation-prone connection route the deviation-prone connection route identifying unit 18 identifies back to the mobile-body navigation device 1. In this configuration, if any alteration in the information about the deviation-prone connection route is detected from the probe information, the probe server 3 transmits the information about the deviation-prone connection route after the alteration to the mobile-body navigation device 1 that uses the route including the deviation-prone connection route indicated by the information as the guide route. In this way, it can send the latest information to the mobile-body navigation device 1 which has the information altered about the deviation-prone connection route on the guide route.

Although the foregoing embodiment 1 shows an example that applies the mobile-body navigation device 1 in accordance with the present invention to an onboard navigation device, it is applicable not only to an onboard device, but also to a mobile phone terminal or portable information terminal (PDA: Personal Digital Assistance).

In addition, it can also be applied to a PND (Portable Navigation Device) a person brings into a mobile body such as a vehicle, train, ship or aircraft to use.

Incidentally, it is to be understood that variations of any components of the embodiment or removal of any components of the embodiment is possible within the scope of the present invention.

### INDUSTRIAL APPLICABILITY

A mobile-body navigation device in accordance with the present invention is capable of deciding on an appropriate route, taking account of a deviation-prone connection route which often misleads a user into a wrong route. Accordingly, it is suitable for an onboard navigation device.

### DESCRIPTION OF REFERENCE SYMBOLS

1 mobile-body navigation device; 2 vehicle; 3 probe server; 4 communication network; 5 navigation processing unit; 6 GPS receiver; 7 communication device; 8 display device; 8a input unit; 9 communication interface unit; 10 positional information acquiring unit; 11 map database (DB); 12 route search unit; 13 map display unit; 14 deviation-prone connection route caution instructing unit; 15 probe information processing unit; 16 cache update unit; 17 deviation-prone connection route cache; 18 deviation-prone connection route identifying unit; 19 probe database (DB); 20 probe DB access unit; 21 probe data acquiring unit; 22 terminal information processing unit; 23 information returning unit; 24 communication interface unit.

1. A mobile-body navigation device comprising:
a route searching unit that searches for a route to a destination;
a receiver that receives information about a deviation-prone connection route on the route identified in accordance with probe information;
an instructing unit that gives instructions to send notification of presence or absence of a deviation-prone connection route on the route the route searching unit searches for in accordance with the information about the deviation-prone connection route the receiver receives; and
a display controller that displays a guide map including the presence or absence of the deviation-prone connection route on the route in response to the instructions.

2. The mobile-body navigation device according to claim 1, further comprising:
a deviation-prone connection route storage that stores the information about the deviation-prone connection route the receiver receives, wherein the instructing unit gives the instructions to send notification of the presence or absence of the deviation-prone connection route on the route the route searching unit searches for in accordance with the information about the deviation-prone connection route read out of the deviation-prone connection route storage.

3. The mobile-body navigation device according to claim 1, wherein when the receiver fails to receive the information about the deviation-prone connection route, the receiver retries to receive the information about the deviation-prone connection route.

4. The mobile-body navigation device according to claim 1, further comprising:
an input device that accepts input, wherein
the instructing unit gives the route searching unit instructions to re-search a route when the input device accepts a request for re-searching for a route; and
the route searching unit receives the instructions and re-searches for the route.

5. The mobile-body navigation device according to claim 1, wherein the receiver receives the information about the deviation-prone connection route at intervals of a prescribed distance covered by a mobile body or at intervals of a prescribed elapsed time.

6. A mobile-body navigation system comprising:
a mobile-body navigation device as defined in claim 1; and
a probe server comprising a deviation-prone connection route identifying unit that identifies a deviation-prone connection route on a route by collecting probe information, and a returning unit that sends the information about the deviation-prone connection route the deviation-prone connection route identifying unit identifies back to the mobile-body navigation device.

7. The mobile-body navigation system according to claim 6, wherein the probe server transmits, if any alteration in the information about the deviation-prone connection route is detected from the probe information, the information about the deviation-prone connection route after the alteration to the mobile-body navigation device that uses as the guide route the route including the deviation-prone connection route indicated by the information about the deviation-prone connection route.
